(19) United States
(12) Patent Application Publication
(10) Pub. No.: US 2005/0134025 A1
(43) Pub. Date: Jun. 23, 2005

(54) Inflatable curtain

(75) Inventors: Stephen A. Ridella, Rochester, MI (US); Bruce R. Hill, Bloomfield Hills, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/742,491

(22) Filed: Dec. 19, 2003

(51) Int. Cl. B60R 21/22

(52) U.S. Cl. 280/730.2

(57) ABSTRACT

Apparatus (10) for helping to protect an occupant of a vehicle (12) includes an inflatable curtain (14) that is inflatable away from a vehicle roof (18) of the vehicle to a position between a side structure (16) of the vehicle and a vehicle occupant. The inflatable curtain (14) has a length and includes opposite end portions (64 and 66) spaced apart along its length. The inflatable curtain (14) includes a portion that overlies a B pillar (32) of the vehicle (12). The inflatable curtain (14) has a first portion that has a first vertical height and extends from adjacent the B pillar (32) to one of the end portions (64 and 66). The inflatable curtain (14) has a second portion that has a second vertical height and extends from adjacent the B pillar (32) to the other of the end portions (64 and 66). The first and second vertical heights are different from each other.

### FIELD OF THE INVENTION

The present invention relates to an inflatable apparatus for helping to protect a vehicle occupant in the event of a side impact to the vehicle and/or a vehicle rollover.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that inflates away from the roof of the vehicle downward inside the passenger compartment between a vehicle occupant and the side structure of the vehicle in the event of a side impact or rollover. A known inflatable curtain is inflated from a deflated condition by inflation fluid directed from an inflator to the inflatable curtain.

### SUMMARY OF THE INVENTION

The present invention relates to an apparatus for helping to protect an occupant of a vehicle. The apparatus includes an inflatable curtain that is inflatable away from a vehicle roof of the vehicle to a position between a side structure of the vehicle and a vehicle occupant. The inflatable curtain has a length and includes opposite ends spaced apart along its length. The inflatable curtain includes a portion that overlies a B pillar of the vehicle. The inflatable curtain has a first portion that has a first vertical height and extends from adjacent the B pillar to one of the end portions. The inflatable curtain has a second portion that has a second vertical height and extends from adjacent the B pillar to the other of the end portions. The first and second vertical heights are different from each other.

The present invention also relates to an apparatus for helping to protect an occupant of a vehicle that has a side structure and a roof. The apparatus includes an inflatable curtain that is inflatable away from the vehicle roof to a position between the side structure of the vehicle and a vehicle occupant. The inflatable curtain has a front portion that extends forward in the vehicle from adjacent a B pillar of the vehicle. The inflatable curtain also includes a rear portion that extends rearward in the vehicle from adjacent the B pillar. The front portion has a first vertical height and the rear portion has a second vertical height. The first vertical height is greater than the second vertical height.

The present invention further relates to an apparatus for helping to protect an occupant of a vehicle that has a side structure and a roof. The apparatus includes an inflatable curtain that is inflatable away from the vehicle roof to a position between the side structure of the vehicle and a vehicle occupant. The inflatable curtain has a front portion extending forward in the vehicle from adjacent a B pillar of the vehicle and a rear portion extending rearward in the vehicle from adjacent the B pillar. The front portion has a first vertical height and the rear portion has a second vertical height that is greater than the first vertical height.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant illustrating the apparatus in a deflated condition in a vehicle, according to a first embodiment of the present invention;

FIG. 2 is a schematic view of the apparatus of FIG. 1 in an inflated condition in the vehicle;

FIG. 3 is a schematic view of a portion of the apparatus of FIGS. 1 and 2 in a non-inflated condition;

FIG. 4 is a schematic view illustrating the manufacture of the portion of FIG. 3;

FIG. 5 is a schematic view of an apparatus for helping to protect a vehicle occupant illustrating the apparatus in an inflated condition in a vehicle, according to a second embodiment of the present invention; and

FIG. 6 is a schematic view of a portion of the apparatus of FIG. 5 in a non-inflated condition.

### DESCRIPTION OF EMBODIMENTS

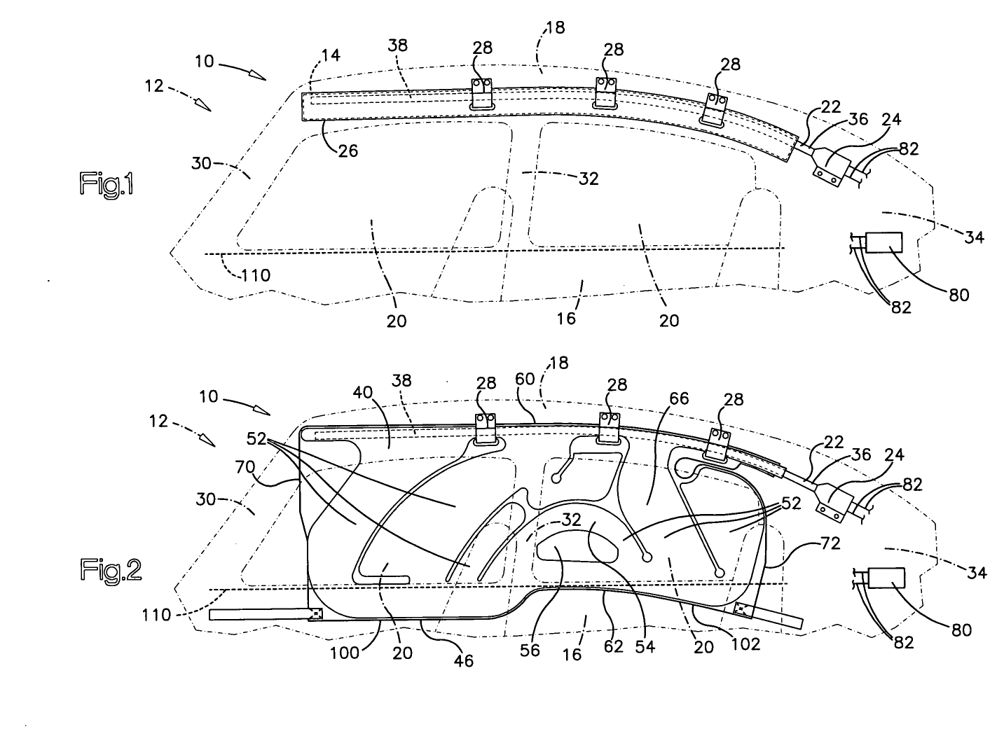

Representative of the present invention, an apparatus 10 helps to protect an occupant of a vehicle 12. As shown in FIGS. 1 and 2, the apparatus 10 includes an inflatable vehicle occupant protection device in the form of an inflatable curtain 14 that is mounted adjacent the side structure 16 of the vehicle 12 and the roof 18 of the vehicle. The side structure 16 of the vehicle 12 includes side windows 20, an A pillar 30, a B pillar 32, and a C pillar 34. An inflator 24 is connected in fluid communication with the inflatable curtain 14 through a fill tube 22. The fill tube 22 may be constructed of any suitable material, such as metal, plastic, or fabric. Also, those skilled in the art will appreciate that the fill tube 22 may be omitted, in which case the inflator 24 may be connected directly to the inflatable curtain 14.

The fill tube 22 has a first end portion 36 for receiving fluid from the inflator 24. The fill tube 22 may be connected directly to the inflator 24 or a manifold (not shown) may connect the fill tube to the inflator. The fill tube 22 has a second end portion 38 disposed in the inflatable curtain 14.

The inflator 24 contains a stored quantity of pressurized inflation fluid (not shown) in the form of a gas to inflate the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 may include a housing 26 (FIG. 1) that stores the inflatable curtain 14 in a stored and deflated condition. The fill tube 22, the deflated inflatable curtain 14, and the housing 26 have an elongated configuration and extend along the vehicle roof 18 and along the side structure 16 of the vehicle 12 above the side windows 20. The fill tube 22, inflatable curtain 14 and housing 26 are connected to the vehicle 12 by known means 28, such as brackets.

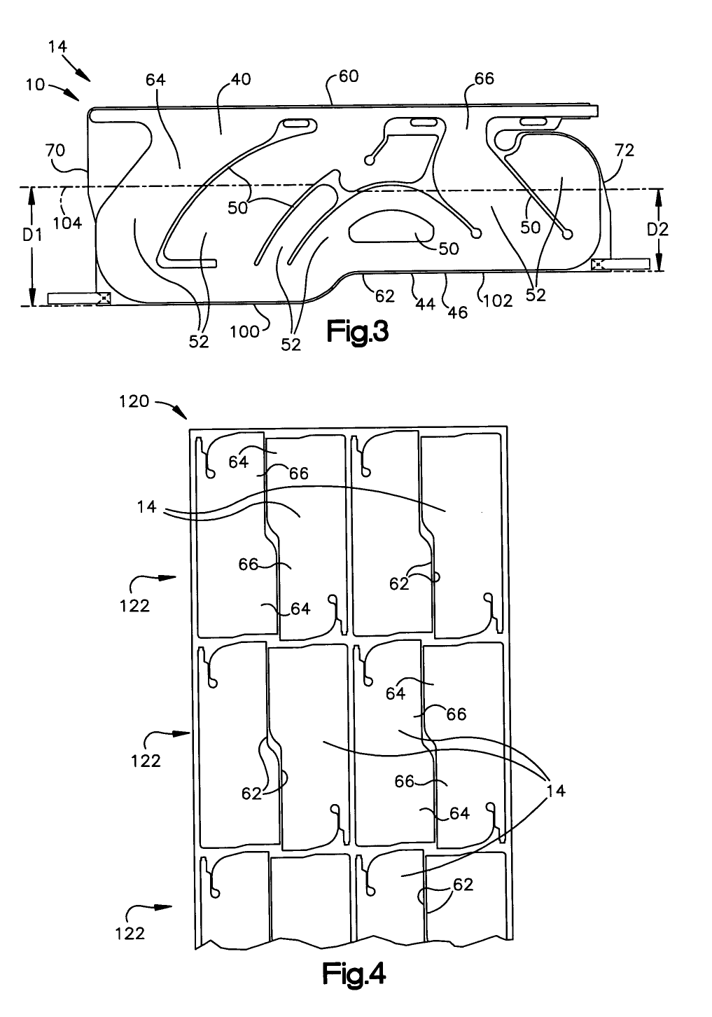

Referring to FIGS. 2 and 3, the inflatable curtain 14 includes panels 40 of material that are arranged in an overlying manner. Overlapping portions of the panels are secured together by weaving the panels together along at least a portion of a perimeter 44 of the inflatable curtain 14 to form a perimeter connection 46 of the curtain. The perimeter connection 46 helps define an inflatable volume of the inflatable curtain 14.

The inflatable curtain 14 may also include interior connections 50 in which the overlying panels 40 are interconnected within the perimeter 44 of the curtain. The interior connections 50 form non-inflatable portions of the inflatable curtain 14 within the perimeter 44 of the curtain. The interior connections 50 also help define inflatable chambers 52 of the inflatable curtain 14. In the configuration of the inflatable curtain 14 illustrated in FIG. 3, one of the chambers 52, identified at 54, has a curved configuration and extends from forward of the B pillar 32 to rearward of the B pillar and covers a portion of the B pillar. One of the interior connections 50, identified at 56, forms a non-inflatable area positioned adjacent or near the B pillar 32. The configuration of the interior connections 50, and thus the chambers 52, may vary depending on a variety of factors, such as the architecture of the vehicle 12, the position of the inflatable curtain 14 in the vehicle, and the desired extent or coverage of the curtain.

The panels 40 are woven from a material, such as nylon yarn, and may be coated with a gas impermeable material, such as urethane, or laminated with a gas impermeable film. The inflatable curtain 14 thus may have a substantially gas-tight construction. Those skilled in the art will appreciate that alternative materials, such as polyester yarn, and alternatives coatings, such as silicone, may also be used to construct the inflatable curtain 14.

The inflatable curtain 14 includes an upper edge 60, an opposite lower edge 62, and front and rear portions 64 and 66, respectively, that extend between the upper and lower edges. The front portion 64 includes a front edge 70 of the inflatable curtain 14. The rear portion 66 includes a rear edge 72 of the inflatable curtain 14. The perimeter 44 of the inflatable curtain 14 is defined at least partially by the upper edge 60, lower edge 62, front edge 70, and rear edge 72. A front portion 100 of the lower edge 60 extends along the front portion 64 of the inflatable curtain 14. A rear portion 102 of the lower edge 60 extends along the rear portion 66 of the inflatable curtain 14.

In the embodiment illustrated in FIG. 2, the front and rear edges 70 and 72 extend between the upper and lower edges 60 and 62 and help define respective terminal end portions of the inflatable curtain 14. Those skilled in the art, however, will appreciate that the inflatable curtain 14 may have a shape that differs from that of the curtain of the illustrated embodiment. For example, in the illustrated embodiment, the rear edge 72 could be omitted and the upper and lower edges 60 and 62 could be curved and extended until they intersect, in which case the rear portion 66 would be defined by the intersecting upper and lower edges.

The vehicle 12 includes a sensor mechanism 80 (shown schematically in FIGS. 1 and 2) for sensing the occurrence of an event for which occupant protection is desired, such as a side impact to the vehicle 12 and/or a vehicle rollover. Upon sensing the occurrence of such an event, the sensor mechanism 80 provides an electrical signal over lead wires 82 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. The inflatable curtain 14 inflates away from the roof 18 in a downward direction as shown in the drawings and in a downward direction with respect to the direction of forward travel of the vehicle 12 into the position illustrated in FIG. 2.

The inflatable curtain 14, when inflated, extends along the side structure 16 of the vehicle 12 and is positioned between the side structure and any occupant of the vehicle. The inflatable curtain 14 extends between the A pillar 30 and the C pillar 34 of the vehicle 12 and may overlie portions of the A pillar, C pillar, and the B pillar 32 of the vehicle. The front and rear portions 64 and 66 meet each other at a location adjacent or near the B pillar 32 of the vehicle 12. The front portion 64 of the inflatable curtain 14 extends from adjacent or near the B pillar 32 to the front edge 70, adjacent or near the A pillar 30. The rear portion 66 of the inflatable curtain 14 extends from adjacent or near the B pillar 32 to the rear edge 72, adjacent or near the C pillar 34. The extents of the front and rear portions 64 and 66 could vary, depending on factors such as the architecture of the vehicle 12 and the desired vehicle coverage.

The inflatable curtain 14, when inflated, helps to protect a vehicle occupant in the event of a vehicle rollover and/or a side impact to the vehicle 12. The inflatable curtain 14, when inflated, helps to absorb the energy of impacts with the curtain and helps to distribute the impact energy over a large area of the curtain.

According to the present invention, the inflatable curtain 14 has a stepped configuration in which the front and rear portions 64 and 66 of the curtain have different vertical heights. More specifically, in the embodiment of FIGS. 1 and 2, the front portion 64 has a vertical height that is greater than the vertical height of the rear portion 66.

By “vertical height,” it is meant to describe the height of the front and rear portions 64 and 66 as measured vertically in FIGS. 2 and 3. Referring to FIGS. 2 and 3, it will be appreciated that the differential between the vertical heights of the front and rear portions 64 and 66 is effectuated through the stepped configuration of the lower edge 62 of the curtain 14. These different vertical heights may be quantified in reference to a longitudinal axis 104 (FIG. 3) of the inflatable curtain 14.

When the inflatable curtain 14 is in the non-inflated and flattened condition of FIG. 3, the vertical height of the front portion 64 of the curtain may be quantified as a first distance, indicated at D1, from the axis 104 to the front portion 100 of the lower edge 62. The vertical height of the rear portion 66 of the curtain may be quantified as a second distance, indicated at D2, from the axis 104 to the rear portion 102 of the lower edge 62. The difference in these first and second distances D1 and D2 thus equals the difference in vertical height between the front and front and rear portions 64 and 66 of the inflatable curtain 14. The difference in vertical height between the front and rear portions 64 and 66 may vary. For example, the difference in vertical height between the front and rear portions 64 and 66 may be 15% or more.

In the configuration of FIG. 3, the vertical heights of the front and rear portions 64 and 66 could be measured between the upper and lower edges 60 and 62, since the upper and lower edges extend generally parallel to each other. Those skilled in the art, however, will appreciate that the upper and lower edges 60 and 62 may not be parallel. In this instance, measurement of the vertical heights from the axis 104 still yields an accurate depiction of the difference in vertical heights of the front and rear portions 60 and 62.

Referring to FIG. 3, the upper edge 60 of the inflatable curtain 14 when in the non-inflated and flattened condition, extends generally parallel to the axis 104. When installed in the vehicle 12 (FIG. 2), however, the upper edge 60 is arranged along the curved configuration of the vehicle roof 18. Because of this, when the inflatable curtain 14 is in the inflated condition, the rear portion 66 of the inflatable curtain 14 is positioned vertically downward relative to the front portion 64 of the curtain. As a result, the rear portion 102 of the lower edge 62 may have portions positioned at about the same vertical extent in the vehicle 12 as the front portion 100 of the lower edge.

The front and rear portions 64 and 66 of the inflatable curtain 14, when inflated, may thus extend from adjacent or near the vehicle roof 18 down to a desired position along the side structure 16. In the embodiment of FIG. 2, the front and rear portions 64 and 66 extend down to adjacent or below a belt line 110 of the vehicle 12. The belt line 110 extends along the side structure 16 just below the side windows 20 along the area where interior trim (not shown) of the side structure, e.g., door panels, form a lower portion or sill of the side window openings.

The front portion 64 may thus cover a portion of the side structure 16 adjacent or below the belt line 110 that extends from adjacent or near the A pillar 30 to adjacent or near the B pillar 32. The rear portion 66 may thus cover a portion of the side structure 16 adjacent or below the belt line 110 that extends from adjacent or near the B pillar 32 to adjacent or near the C pillar 34. The stepped configuration of the lower edge 62 of the inflatable curtain 14 thus utilizes the architecture of the vehicle 12, i.e., the curved roof 18, to provide a desired amount of vehicle coverage.

According to one embodiment of the present invention, the inflatable curtain 14 of FIGS. 2 and 3 may be woven on a loom in a continuous weaving process in which several curtains are woven simultaneously in a sheet and then cut out to separate the individual curtains. FIG. 4 illustrates an example of multiple curtains 14 woven in a sheet 120.

As shown in FIG. 4, the stepped configuration of the inflatable curtains 14 allows the curtains to be nested in rows 122 extending across a width of the sheet 120. In this nested configuration, the curtains 14 are arranged in pairs with the lower edges 62 of each curtain in the pair being positioned adjacent to each other. The curtains 14 in each pair are arranged such that the front portion 64 of each curtain of the pair is positioned adjacent the rear portion 66 of the other curtain of the pair. Because of this, the curtains 14 in each pair may be positioned close to each other and the space provided by the shortened vertical height of the rear portions 66 may receive the front portions 64. This helps to minimize the width of the sheet 120 required to accommodate a given number of curtains 14 in a row 122. Conversely, for a sheet 120 having a given width, this may help maximize the number of curtains 14 that may be woven in a given row 122.

For example, for the configuration of the inflatable curtain 14 of FIG. 3, the vertical height of the curtain may measure about 615 millimeters from the upper edge 60 to the lower edge 62 in the front portion 64 of the curtain. In the rear portion 66 of the curtain 14, the vertical height may measure about 515 millimeters from the upper edge 60 to the lower edge 62.

To produce the curtains 14 in rows 122 of four without nesting the curtains as shown in FIG. 4, the width of the sheet 120 would need to be at least about 4×615 millimeters, i.e., 2460 millimeters. This does not take into account providing spacing between the individual curtains 14 in the rows 122 to facilitate cutting the curtains from the woven sheet 120. Allowing 10 millimeters spacing along the upper and lower edges 60 and 62 of each curtain 14 to facilitate cutting out the curtains would increase the required width of the sheet 120 to about 2540 millimeters.

The difference in vertical height between the front and rear portions 64 and 66 is about 100 millimeters. Thus, producing the curtains 14 in rows 122 of four while nesting the curtains as shown in FIG. 4 may reduce the width of the sheet 120 by about 100 millimeters for each nested pair of curtains in the row. Allowing 10 millimeters spacing along the upper and lower edges 60 and 62 of each curtain 14 to facilitate cutting out the curtains would result in the sheet 120 having a width of about 2340 millimeters.

The reduction in width of the sheet 120 facilitated by the stepped configuration of the inflatable curtain 14 may thus provide a reduction in material (i.e., yarn) of about 8.2% over weaving in rows 122 of four without nesting. This may also reduce the amounts of other materials, such as coatings and laminates, that are required to manufacture the curtains 14. Producing the curtains 14 in nested rows 122 thus may provide a cost savings over producing the curtains in non-nested rows.

Those skilled in the art will appreciate that manufacturing equipment, such as looms, scouring machines, cutting machines, and lamination and coating machines may limit the width of the sheet 120 to a width that the respective machines are capable of processing. For some of this equipment, this limit in sheet width may fall at about 2500 millimeters. For the example dimensions given above, the non-nested curtains would exceed this limit. In this instance, the curtains 14 cannot be produced in rows of four, which would dictate that the curtains be produced in rows of three. If produced in the nested configuration of FIG. 4, however, the curtains 14 can be produced in rows of four and fall well within the 2500 millimeter width limit for the sheet.

It will thus be appreciated that, through the stepped curtain configuration of the present invention, the inflatable curtain 14 may be produced in rows of four instead of rows of three, which would amount to a 33% increase in the number of curtains produced per unit length of the sheet. The processing costs, i.e., the non-material costs associated with warping, sizing, weaving, scouring, and applying lamination or sealant remain about the same regardless of whether the curtains are produced in rows of three or four. The incremental costs associated with producing the curtains in rows of four as opposed to rows of three may be limited to material costs and cutting costs. As a result, the stepped configuration of the inflatable curtain 14 thus may help reduce manufacturing costs of the curtain on a cost per curtain basis.

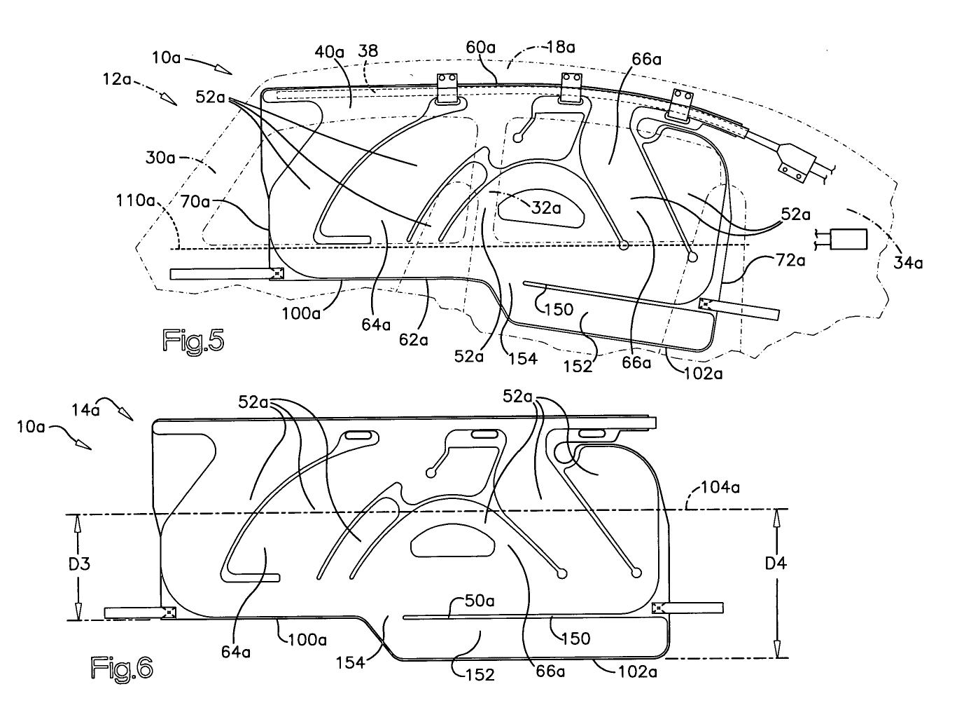

A second embodiment of the present invention is illustrated in FIGS. 5 and 6. The second embodiment of the present invention is similar to the first embodiment of the invention illustrated in FIGS. 1-4. Accordingly, reference numbers similar to those of FIGS. 1-4 will be utilized in FIGS. 5 and 6, the suffix letter “a” being associated with the reference numbers of FIGS. 5 and 6 to avoid confusion.

As shown in FIGS. 5 and 6, inflatable curtain 14a has a stepped configuration in which the front and rear portions 64a and 66a of the inflatable curtain have different vertical heights. More specifically, in the embodiment of FIGS. 5 and 6, the rear portion 66a has a vertical height that is greater than the vertical height of the front portion 64a.

By “vertical height,” it is meant to describe the height of the front and rear portions 64a and 66a as measured vertically in FIGS. 5 and 6. Referring to FIGS. 5 and 6, it will be appreciated that the differential between the vertical heights of the front and rear portions 64a and 66a is effectuated through the stepped configuration of the lower edge 62a of the curtain 14a. These different vertical heights may be quantified in reference to a longitudinal axis 104a (FIG. 6) of the inflatable curtain 14a.

When the inflatable curtain 14a is in the non-inflated and flattened condition of FIG. 6, the vertical height of the front portion 64a of the curtain may be quantified as a third distance, indicated at D3, from the axis 104a to the front portion 100a of the lower edge 62a. The vertical height of the rear portion 66a of the curtain may be quantified as a fourth distance, indicated at D4, from the axis 104a to the rear portion 102a of the lower edge 62a. The difference in these third and fourth distances D3 and D4 thus equals the difference in vertical height between the front and front and rear portions 64a and 66a of the inflatable curtain 14a. The difference in vertical height between the front and rear portions 64a and 66a may vary. For example, the difference in vertical height between the front and rear portions 64a and 66a may be 15% or more.

Referring to FIGS. 5 and 6, the inflatable curtain 14a includes an interior connection 50a, identified at 150, that helps define a lower chamber 152 of the rear portion 66a of the curtain. The lower chamber 152 may be positioned entirely below the front portion 100a of the lower edge 62a when the inflatable curtain 14a is in the inflated condition of FIG. 5. The connection 150 also helps define a passage 154 for directing inflation fluid from the other chambers 52a of the inflatable curtain 14a into the chamber 152. Since the lower chamber 152 forms the lowermost inflatable portion of the inflatable curtain 14a, the lower chamber may begin inflating after the remaining chambers 52a of the curtain begin inflating.

When the inflatable curtain 14a is in the inflated condition of FIG. 5, the upper edge 60a is positioned adjacent the vehicle roof 18a. The lower edge 62a is positioned below the belt line 110a of the vehicle 12a. The front edge 70a is positioned adjacent the A pillar 30a. The rear edge 72a is positioned adjacent the C pillar 34a.

The front portion 64a of the inflatable curtain 14a, when inflated, extends from adjacent or near the vehicle roof 18a down to below the belt line 110a of the vehicle 12a. The front portion 64a may thus cover a portion of the side structure 16a below the belt line 110a that extends from adjacent or near the A pillar 30a to adjacent or near the B pillar 32a.

The rear portion 66a of the inflatable curtain 14a, when inflated, extends from adjacent or near the vehicle roof 18a down to below the belt line 110a of the vehicle 12a. Because the upper edge 60a is arranged along a curved portion of the vehicle roof 18a, the rear portion 66a may extend further downward when the inflatable curtain 14a is in the inflated condition. The rear portion 66a, particularly the lower chamber 152, may thus cover a portion of the side structure 16a below the belt line 110a that extends from adjacent or near the B pillar 32a to adjacent or near the C pillar 34a. The lower chamber 152, extending below the belt line 110a, may have an inflated position adjacent the head and/or torso of a small occupant, such as a child (not shown) occupying a rear vehicle seat.

It will thus be appreciated that the stepped configuration of the inflatable curtain 14a of the second embodiment helps provide extended coverage below the belt line 110a in the rear portion 66a of the curtain. It will also be appreciated that, through the stepped curtain configuration, the inflatable curtain 14a may be manufactured in sheets with multiple curtains nested together in rows, as described above in regard to the first embodiment (FIGS. 1-4). The stepped configuration of the inflatable curtain 14a of the second embodiment (FIGS. 5 and 6) may thus provide manufacturing cost savings similar to those described above in regard to the first embodiment.

From the above description of the invention, those skilled in the art will perceive improvements, changes and modifications. Such improvements, changes and modifications within the skill of the art are intended to be covered by the appended claims.

1. Apparatus for helping to protect an occupant of a vehicle that has a side structure and a roof, said apparatus comprising:
an inflatable curtain that is inflatable away from the vehicle roof to a position between the side structure of the vehicle and a vehicle occupant, said inflatable curtain having a length and including opposite end portions spaced apart along its length, said inflatable curtain including a portion that overlies a B pillar of the vehicle;
said inflatable curtain having a first portion having a first vertical height and extending from adjacent the B pillar to one of said end portions, said inflatable curtain having a second portion having a second vertical height and extending from adjacent the B pillar to the other of said end portions, said first and second vertical heights being different from each other.

2. The apparatus recited in claim 1, wherein said vertical height is measured between spaced and generally parallel upper and lower edges of said inflatable curtain.

3. The apparatus recited in claim 1, wherein said vertical height is measured between a lower edge of said inflatable curtain and a longitudinal axis of said inflatable curtain.

4. The apparatus recited in claim 1, wherein said inflatable curtain comprises a plurality of inflatable chambers, at least one of said chambers having a curved configuration and extending from between the B pillar and said first end portion to between the B pillar and said second end portion.

5. The apparatus recited in claim 1, wherein said first portion of said inflatable curtain comprises a front portion extending forward from adjacent the B pillar to one of said opposite end portions, and said second portion of said inflatable curtain comprises a rear portion extending rearward from adjacent the B pillar to the other of said opposite end portions.

6. The apparatus recited in claim 5, wherein said inflatable curtain comprises a plurality of inflatable chambers, at least one of said chambers having a curved configuration extending from said front portion into said rear portion of said inflatable curtain.

7. The apparatus recited in claim 5, wherein said front portion has a vertical height that is greater than a vertical height of said rear portion.

8. The apparatus recited in claim 5, wherein said front portion has a vertical height that is at least 15% greater than a vertical height of said rear portion.

9. The apparatus recited in claim 7, wherein the vertical height of said front portion is sufficient to extend down to adjacent or below a belt line of the vehicle when the inflatable curtain is inflated, said rear portion being fixed to a portion of the vehicle roof having a curved downward configuration such that said rear portion when inflated extends down to adjacent or below the belt line of the vehicle.

10. The apparatus recited in claim 5, wherein said rear portion has a vertical height that is greater than a vertical height of said front portion.

11. The apparatus recited in claim 5, wherein said rear portion has a vertical height that is at least 15% greater than a vertical height of said front portion.

12. The apparatus recited in claim 10, wherein said rear portion comprises a chamber that extends vertically lower than said front portion.

13. The apparatus recited in claim 10, wherein said rear portion comprises a chamber that extends entirely vertically below the lower edge of the front portion.

14. Apparatus for helping to protect an occupant of a vehicle that has a side structure and a roof, said apparatus comprising:
an inflatable curtain that is inflatable away from the vehicle roof to a position between the side structure of the vehicle and a vehicle occupant, said inflatable curtain having a front portion extending forward in the vehicle from adjacent a B pillar of the vehicle, and a rear portion extending rearward in the vehicle from adjacent the B pillar;
said front portion having a first vertical height, said rear portion having a second vertical height, said first vertical height being greater than said second vertical height.

15. The apparatus recited in claim 14, wherein said first vertical height is at least 15% greater than said second vertical height.

16. The apparatus recited in claim 14, wherein said front portion extends from adjacent the B pillar forward to adjacent an A pillar of the vehicle and said rear portion extends from adjacent the B pillar rearward to adjacent a C pillar of the vehicle.

17. The apparatus recited in claim 14, wherein said front portion extends from adjacent the roof of the vehicle down to adjacent a belt line of the vehicle, and said rear portion being fixed to a portion of the vehicle roof having a curved downward configuration such that said rear portion when inflated extends down to the belt line of the vehicle.

18. The apparatus recited in claim 14, wherein said inflatable curtain comprises at least one inflatable chamber having a curved configuration and extending from said front portion into said rear portion of said inflatable curtain.

19. The apparatus recited in claim 14, wherein said inflatable curtain comprises at least one non-inflatable portion positioned adjacent the B-pillar of the vehicle when said inflatable curtain is inflated.

20. Apparatus for helping to protect an occupant of a vehicle that has a side structure and a roof, said apparatus comprising:
an inflatable curtain that is inflatable away from the vehicle roof to a position between the side structure of the vehicle and a vehicle occupant, said inflatable curtain having a front portion extending forward in the vehicle from adjacent a B pillar of the vehicle, and a rear portion extending rearward in the vehicle from adjacent the B pillar;
said front portion having a first vertical height, said rear portion having a second vertical height that is greater than said first vertical height.

21. The apparatus recited in claim 20, wherein said second vertical height is at least 15% greater than said first vertical height.

22. The apparatus recited in claim 20, wherein said front portion extends from adjacent the B pillar forward to adjacent an A pillar of the vehicle and said rear portion extends from adjacent the B pillar rearward to adjacent a C pillar of the vehicle.

23. The apparatus recited in claim 20, wherein said front portion extends from adjacent the roof of the vehicle down to adjacent a belt line of the vehicle, and said rear portion extends from adjacent the roof of the vehicle down to below the belt line of the vehicle.

24. The apparatus recited in claim 20, wherein said inflatable curtain comprises at least one inflatable chamber having a curved configuration and extending from said front portion into said rear portion of said inflatable curtain.

25. The apparatus recited in claim 20, wherein said inflatable curtain comprises at least one non-inflatable portion positioned adjacent the B-pillar of the vehicle when said inflatable curtain is inflated.
